(19) United States
(12) Patent Application Publication
(10) Pub. No.: US 2008/0004038 A1
(43) Pub. Date: Jan. 3, 2008

(54) PUSH-TO-TALK PROXIMITY-BASED CONFIGURATION

(76) Inventor: Gregory A. Dunko, Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/427,857

(22) Filed: Jun. 30, 2006

(51) Int. Cl. H04Q 7/20

(52) U.S. Cl. 455/456.1

(57) ABSTRACT

A mobile communication device is provided that includes a wireless transceiver, a memory for storing contact information relating to other mobile communication devices of individuals and/or groups of individuals with whom the mobile communication device may communicate via the wireless transceiver; and a proximity-based configuration processor. The proximity-based configuration processor receives location information relating to locations of the other mobile communication devices, and configures the mobile communication device to communicate with the other mobile communication devices of the individuals and/or groups of individuals with a priority based on the location information.

### TECHNICAL FIELD OF THE INVENTION

The present invention relates generally to mobile communication systems, and more particularly to push-to-talk enabled mobile communication devices.

### DESCRIPTION OF THE RELATED ART

Mobile communication devices, such as mobile phones, have become enormously popular over the last decade. Whether for professional or personal use, seemingly everybody, young and old alike, has their own mobile phone for communicating with friends, family, customers, colleagues, etc.

Mobile phones today offer a variety of features in addition to conventional two-way calling among parties. For example, mobile phones typically offer three-way calling, call waiting, caller identification (ID), etc., as found in conventional land-based telephones. Moreover, mobile phones nowadays typically offer additional features such as built-in media players, cameras, web-browsing, email capability, etc. Such features serve to enhance the productivity and enjoyment level of the user.

One particular feature of mobile phones that has been gaining in acceptance and usage is referred to as push-to-talk (PTT) or “walkie-talkie” operation. At the push of a button on a PTT capable mobile phone, the mobile phone becomes similar to a walkie-talkie in operation. This allows a user to talk to other users from a contacts list individually or in a predefined group who are logged in, without having to make a phone call. For example, the site manager at a multi-storied building site may want to know who is using the nail gun. Rather than making lots of calls to the mobile phones of each of the construction crew, the site manager may instead simply pick up a PTT enabled mobile phone, push the transmit button, and ask the entire crew with a single transmission. All the crew who are logged into the group can hear the question, and the nail gun may be quickly located—saving time and money.

PTT operation brings walkie-talkie style communication to mobile phone users, enabling them to initiate an individual or group talk (phone conference) session with their circle of friends, colleagues and other contacts on a one-to-one or one-to-many basis. The contacts list is enhanced with information about the availability of each contact and calls can be started with just a push of a key. Instead of dialing a number to start a conversation, a user may push a button to go to a presence-enabled “contact list”, where the user can view which particular contacts are available (individually or within a predefined group). The user can then select the particular person and/or group members with whom the user wants to communicate.

A mobile phone with PTT capability allows a user to create group call lists so everyone on the group call list can hear the PTT message simultaneously—just as in a telephone conference. Instead of having to call each recipient individually, a push of the button is all it takes to send a message directly to an entire group of friends or work colleagues.

Despite the aforementioned advantages associated with PTT-enabled mobile phones, there have been some drawbacks. For example, the contacts list for a PTT-enabled mobile phone may be presence-enabled. A contacts manager within the mobile phone determines which particular contacts in the contact list are actually present over the PTT network at a given time. A user initiating the PTT call may find such information helpful in that the user may quickly ascertain whether the intended receiving part(ies) are on network. However, such presence information alone may not be optimum insofar as enabling a user to maximize efficiency.

As a particular example, a construction manager may manage a fleet of drivers. The construction manager may be in need of a particular part across town. Advantageously, the construction manager may have a predefined group “Drivers” in his or her mobile phone contacts list. By initiating a PTT call to the group of drivers, the construction manager can quickly send out a request to all of the drivers of the need for the particular part. The group can then discern via PTT communications which particular driver is in the best position to pick up and deliver the part to the construction manager.

However, disadvantages under such circumstances include that fact that only one of the drivers among the fleet of drivers will be able to actually pick up and deliver the particular part across town. Typically this would be the driver closest in vicinity to the part located across town. Nevertheless, all of the drivers in the group are contacted via the PTT call from the construction manager. Receipt of the call and any resultant PTT communications by those drivers not likely to be in a position to pick up and deliver the part can range from being a minor annoyance to being genuinely disruptive, particularly in the case where the drivers are attempting to drive and communicate via their mobile phone at the same time.

In view of these shortcomings, there is a strong need in the art for a mobile device and system that avoids contacting individuals or members of a group list unnecessarily. More specifically, there is a strong need in the art for a mobile device and system that enables selection of the particular individuals or group members based on criteria beyond simply whether the particular individuals or group members are present on the PTT network.

### SUMMARY

According to an aspect of the invention, a mobile communication device is provided. The mobile communication device includes a wireless transceiver, a memory for storing contact information relating to other mobile communication devices of individuals and/or groups of individuals with whom the mobile communication device may communicate via the wireless transceiver; and a proximity-based configuration processor. The proximity-based configuration processor receives location information relating to locations of the other mobile communication devices, and configures the mobile communication device to communicate with the other mobile communication devices of the individuals and/or groups of individuals with a priority based on the location information.

According to one particular aspect, the proximity-based configuration processor is configured to receive the location information from the other mobile communication devices themselves.

In accordance with another aspect, the proximity-based configuration processor is configured to receive the location information from a system server responsible for providing such information.

According to another aspect, the proximity-based configuration processor is configured to transmit location information requests to the other mobile communication devices to initiate receipt of the location information.

According to still another aspect, the location information requests include at least one waypoint with respect to which the location of the other mobile communications devices is requested.

In accordance with another aspect, the proximity-based configuration processor determines the location of the other mobile communication devices relative to a waypoint based on the received location information.

With still another aspect of the invention, the proximity-based configuration processor is configured to transmit a request for the location information to the system server.

According to yet another aspect, the location information requests include at least one waypoint with respect to which the location of the other mobile communications devices is requested.

According to another aspect, the memory includes a group of individuals, and the proximity-based configuration processor effectuates the priority in a manner in which the group of individuals is displayed to a user in preparation for initiating a push-to-talk (PTT) communication.

In accordance with another aspect, a display of the group of individuals is prioritized in that group members having a nearer location relative to a waypoint are identified with higher priority than group members having a further location.

With yet another aspect, a display of the group of individuals is prioritized in that group members beyond a predetermined distance of a waypoint are not displayed within the group.

According to another aspect, a display of the group of individuals is prioritized in that only the group member closest to a waypoint is displayed within the group.

According to still another aspect, a system includes the mobile communication device and other mobile communication devices. Each of the other mobile communication devices includes location determination circuitry for determining a location of the other mobile communication device; and a wireless transceiver for communicating location information based on the determined location.

In accordance with another aspect, each of the other mobile communication devices is configured to receive location information requests from another mobile device, and to respond by communicating the location information based on the determined location to the mobile device issuing the location information request.

According to still another aspect, the location information communicated by each of the other mobile communication devices comprises the absolute location of the mobile communication device.

In accordance with yet another aspect of the present invention, the location information communicated by each of the other mobile communication devices comprises the location of the mobile communication device relative to a waypoint provided in the information requests.

According to another aspect, each of the other mobile communication devices is configured to receive location information requests from a system server, and to respond by communicating the location information based on the determined location to the system server.

With yet another aspect, the system further includes the system server.

According to another aspect of the present invention, a method of conducting PTT communications among mobile communication devices is provided. The method includes the steps of presenting a group of individuals with whom the mobile communication devices may communicate via a PTT communication; and prioritizing the group of individuals for purposes of the PTT communication based on location information relating to the locations of the individuals.

In accordance with yet another aspect, the location information relates to the locations of the individuals relative to a predefined waypoint.

In accordance with still another aspect, the group of individuals are prioritized by displaying the group members on a mobile communication device initiating the PTT communication in an order based on proximity to the waypoint.

According to another aspect, the group of individuals are prioritized by displaying a reduced number of group members based on their proximity to the waypoint.

With yet another aspect, the predefined waypoint is acquired from a database shared among the group of individuals.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is an environmental view of a mobile communications system utilizing PTT proximity-based configuration capabilities in accordance with the present invention;

FIG. 2 is schematic view of a mobile phone with PTT proximity-based configuration capabilities in accordance with an exemplary embodiment of the present invention;

FIG. 3A represents an exemplary graphical interface showing a group of contact list members with whom a user may communicate via PTT; FIGS. 3B, 3C, 3D and 3E represent exemplary graphical interfaces upon enabling the proximity-based configuration capabilities in accordance with respective alternate exemplary embodiments of the present invention;

FIG. 4 is a block diagram of the mobile phone of FIG. 2 in accordance with the exemplary embodiment of the present invention;

FIG. 5 is a flowchart representing the operation of a mobile phone initiating a PTT communication with proximity-based configuration in accordance with an exemplary embodiment of the present invention;

FIG. 6 is a flowchart representing the operation of a mobile phone for receiving a PTT communication with proximity-based configuration in accordance with an exemplary embodiment of the present invention;

FIG. 7 is a flowchart representing the operation of a mobile phone initiating a PTT communication with proximity-based configuration in accordance with an alternate embodiment of the present invention; and

FIG. 8 is a flowchart representing the operation of a mobile phone initiating a PTT communication with proximity-based configuration in accordance with still another embodiment of the present invention.

### DETAILED DESCRIPTION OF EMBODIMENTS

The present invention will now be described with reference to the drawings, in which like reference numerals refer to like elements throughout.

Many mobile communication devices now come equipped with Push-To-Talk (PTT) capability. This capability is facilitated through use of a “buddy list” of principle contacts that are easily selectable/reachable. Within these buddy lists, a user may select an individual or a group of individuals with whom to communicate. In addition, many mobile communication devices are equipped with some location determination capability (e.g., A-GPS, etc.). With a network of PTT and GPS enabled devices, users in accordance with the present invention may easily know the location of their “buddies” and may act accordingly. The present invention relates to a mobile device and system in which the PTT parameters are based on the distance from/proximity to a known reference point (waypoint).

The PTT parameters may include features such as the “presented” order of the buddy list, the composition of the buddy list group (e.g., adaptively modifying the group list), or the alert used for buddies in proximity to a certain location. The known reference point, or waypoint, may be the present location of the initiating device, a known stored waypoint (such as a store or restaurant), or a retrieved waypoint—such as might be downloaded from a website. The result is that a recipient of a PTT communication in proximity to a waypoint would be “prioritized” in an initiating device's PTT buddy list- for more direct communications.

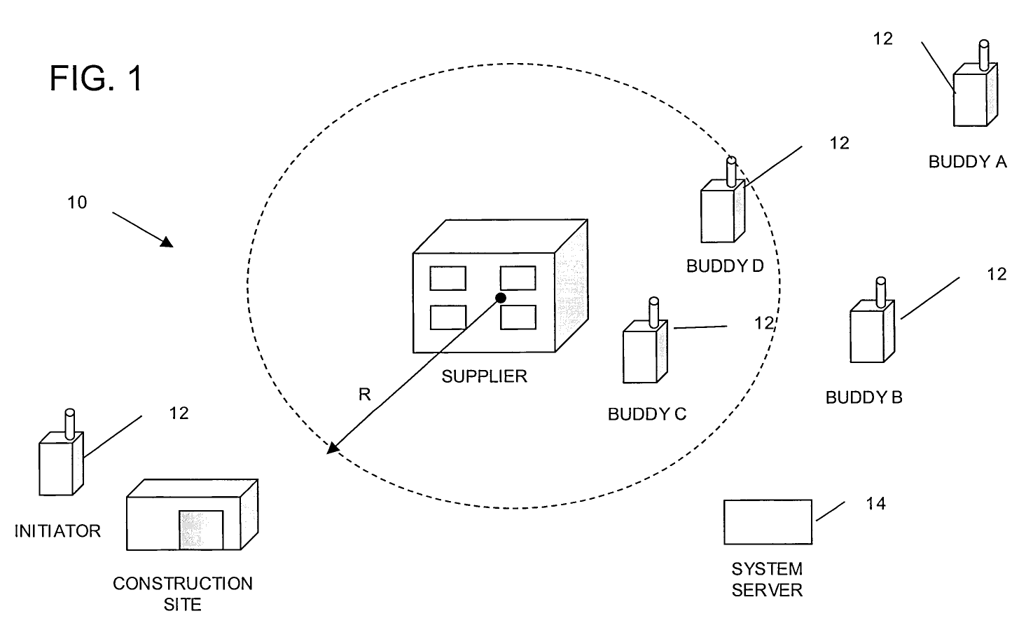

Referring initially to FIG. 1, a mobile communications system utilizing PTT proximity-based configuration capabilities in accordance with the present invention is shown generally as system 10. The system 10 includes a plurality of mobile communication devices (e.g., mobile phones) 12. The mobile phones 12 may be part of a mobile communications network such as any one of the many commercially available mobile communications network providers, e.g., Verizon, Sprint, Alltel, Cingular, Nextel, etc., or a combination thereof. Each of the mobile phones 12 is configured to be able to communicate normally with other mobile phones 12 within the network or affiliated networks in accordance with conventional techniques. In addition, for purposes of describing the features of the present invention, each of the mobile phones 12 shown in FIG. 1 is capable of carrying out conventional push-to-talk (PTT) or “walkie-talkie” operation. Thus, the following description of the present invention will focus primarily on the additional utility provided in one or more of the mobile phones 12 by virtue of PTT proximity-based configuration capabilities in accordance with the present invention.

Suppose the user of one of the mobile phones 12, referred to in FIG. 1 as the “Initiator”, is a the manager of a construction fleet. The manager is overseeing construction at a particular construction site where a garage door is being installed. Because one of the crew at the construction site has broken a unique part while installing the garage door, the manager needs a replacement part from the garage door supplier located across town as quickly as possible.

The manager's mobile phone 12 has stored within its contacts a group (or “buddy”) list representing a group of drivers (e.g., Buddies A, B, C and D) each having their own mobile phone 12. As part of conventional PTT operation, the manager's mobile phone 12 has stored therein a group list that includes Buddies A, B, C and D. The group list may be identified by a name such as “Drivers” or “WorkGroup3”, etc., as will be appreciated.

According to conventional PTT operation, the construction manager may utilize his or her mobile phone in PTT operation to initiate communication with each of Buddies A, B, C and D within the group simultaneously with a simple push of a button. The manager may tell the drivers that a particular garage door part is needed from the Supplier across town. Buddies A, B, C and D can then discern via follow up PTT operation which particular driver is in the best position to pick up the garage door part and deliver it to the construction site. Assuming the Buddies A, B, C and D are physically located as shown in FIG. 1 relative to the supplier, Buddy C is closest to the supplier and presumably could pick up the garage door part and deliver it to the construction site more quickly than the other drivers. Nevertheless, the PTT communication initiated by the construction manager goes out to all of the members of the driver group. Thus, while the construction manager may quickly contact all of the drivers simultaneously, communications to all the drivers except Buddy C are ultimately superfluous, possibly annoying, and maybe even disruptive.

The PTT proximity-based configuration capabilities of the present invention overcome such problems. As will be described in more detail below, the initiating mobile device (e.g., the mobile phone 12 of the construction manager) initiates a PTT communication by first initiating a request for location information relating to selected individuals and/or groups of individuals included in the contacts list of the initiating mobile phone 12. For example, the initiating mobile phone 12 may transmit a request to the mobile phones 12 of each of the Buddies A, B, C and D in the driver group. The request may include waypoint information, such as the location coordinates of a place of interest (e.g., the supplier). The mobile phones 12 of each of the recipients (e.g., of driver Buddies A, B, C and D) are configured to respond to the requests for location information by providing to the initiating mobile phone 12 the relative location of the recipient mobile phone (e.g., relative to the waypoint information provided by the initiating mobile phone 12). Such information may be based, for example, on location information available to each of the recipient mobile phones 12 by way of an internal global positioning satellite (GPS) receiver commonly found in mobile phones nowadays.

The initiating mobile phone 12 receives the location information from each of the recipient mobile phones 12, and based on such information the initiating mobile phone 12 is configured to determine which one, two, three, etc., recipient mobile phones 12 are closet to the waypoint. In the case shown in FIG. 1, the mobile phone 12 of Buddy C would communicate location information back to the manager's mobile phone 12 indicating that Buddy C is closest to the supplier. The initiating mobile phone 12 is designed to self-configure itself so as to present to the manager the identity of Buddy C with priority to distinguish Buddy C over the other Buddies A, B and D in the group. Thus, when the initiating mobile phone 12 initiates the actual PTT communication via the pressing of a button, the PTT communication can be sent exclusively to Buddy C. Consequently, Buddies A, B and D are not bothered.

Alternatively, the initiating mobile phone 12 may receive the location information from each of the recipient mobile phones 12 and determine which recipient mobile phones 12 are within a predefined radius R of the waypoint. The initiating mobile phone 12 in accordance with the present invention is designed to self configure itself so as to present to the user the identity of the group members who are within the predefined radius R of the waypoint (e.g., Buddies C and D). Therefore, when the initiating mobile phone initiates the actual PTT communication, the PTT communication can be sent out exclusively to Buddies C and D. Group members outside of the predefined radius R from the waypoint are not bothered with the PTT communication.

As will be appreciated, variations of the above format may be utilized without departing from the scope of the invention. For example, rather than the initiating mobile phone 12 initially transmitting a location request to each of the individuals or members in a group, the initiating mobile phone 12 may transmit the location request together with recipient individuals or group members identities to a system server 14 included within the system network 12. The system server 14 may be configured to ascertain the respective locations of the individuals or group members (e.g., Buddies A, B, C and D). The system server 14 may then relay the location information of each of the recipient mobile phones 12 to the initiating mobile phone 12. Alternatively, the system server 14 may apply it's own criteria to determine which particular recipient mobile phones 12 have priority over the other recipient mobile phones 12 based on the individual location information. The system server 14 may then respond to the initiating mobile phone 12 with location information indicating simply which recipient mobile phones 12 are entitled to priority. The initiating mobile phone 12 is designed to self-configure itself so as to present to the user of the initiating mobile phone 12 the recipient mobile phones 12 entitled to priority based on the location information provided by the system server 14. Thus, when the initiating mobile phone 12 initiates the actual PTT communication via the pressing of a button, the PTT communication can be sent exclusively to the priority recipient(s). The other recipients are not disturbed with the PTT communication.

The location requests transmitted by the initiating mobile phone 12 to the recipient mobile phones 12 or system server 14 include the waypoint information in one embodiment. In another embodiment, the initiating mobile phone 12 does not provide the waypoint information. The recipient mobile phones 12 or system server 14 simply provide the actual location information of the respective devices. The initiating mobile phone 12 may itself be configured to compute the distance of each of the recipient mobile phones from the waypoint to determine which recipient mobile phone(s) are closest or otherwise have priority based on location relative to the waypoint.

The waypoint information may be obtained by the initiating mobile phone 12 by any suitable technique. For example, the user may input waypoint information in the form of GPS coordinates into the mobile phone 12 via a keypad, optical scanner, etc. Alternatively, the waypoint information may be obtained via the mobile phone 12 accessing the Internet via the wireless network and downloading such waypoint information based on an address entered via a keypad, etc. A database of waypoints may be accessible via the wireless network or elsewhere, and the initiating mobile phone 12 may obtain waypoint information from such database. In the present example, each of the drivers (e.g., Buddies A, B, C and D) may “collect” waypoints that are then entered into a database. For example, each time a driver visits a new supplier the waypoint information for that supplier may be ascertained via the GPS receiver of the driver's mobile phone. Such waypoint information may be stored in the mobile phone and subsequently provided to a shared database from which any of the mobile phones 12 can acquire the information. Moreover, the initiating mobile phone 12 may have its own GPS receiver, and the location of the initiating mobile phone 12 may itself serve as the waypoint information.

A user of a mobile phone 12 wanting to take advantage of the PTT proximity-based configuration of the present invention preferably indicates the same by taking some form of action. For example, prior to carrying out a PTT communication, the user may press a button or key indicating to the phone 12 that the user wishes to utilize PTT proximity-based configuration. Alternatively, the user may simply request that PTT proximity-based configuration represent a default condition. When the user has requested PTT proximity-based configuration, the mobile phone 12 is configured to send out location information requests to the recipients and/or the system server 14 as discussed above automatically whenever the user selects individuals or group lists from the contacts stored in memory in the mobile phone 12. The user may be prompted to enter waypoint information, or the location of the initiating mobile phone 12 itself may serve as a default waypoint unless otherwise entered by the user.

Preferably, the initiating mobile phone 12 is configured to request the location information and the location information is analyzed as to which recipient devices should receive priority, all in the background operation of the mobile phone (e.g., preferably without trouble to the user). The initiating mobile phone 12 receives the location information and configures the phone to allow the user to call the high(est) priority recipient mobile phones with a simple PTT operation, again preferably unbeknownst to the user. The particular communications can be carried out as part of the convention control packets exchanged between mobile phones, the system network, and other mobile phones. For example, such requests and responses may be contained within the SMS portion (or SIP portion if an IP implementation) of the communication packets exchanged over the network between the respective devices, servers, etc. Thus, the user need simply view a display and/or simply press the PTT button to initiate a communication with the priority recipient(s).

Those having ordinary skill in the art of programming communications and operations of mobile communication devices will readily appreciate how to program mobile devices to function in the manner described herein base on the present disclosure. Accordingly, details as to the particular programming are omitted for sake of brevity.

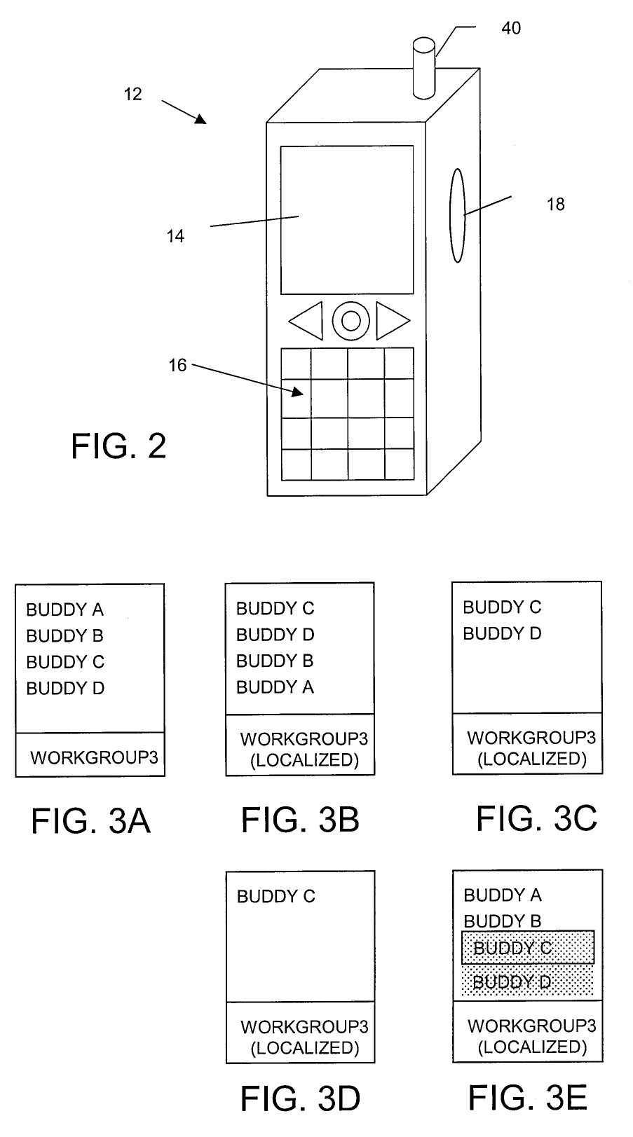

FIG. 2 illustrates an exemplary mobile phone 12 that may function in accordance with the present invention as an initiating mobile phone 12, or recipient mobile phone 12, as will be appreciated. In the exemplary embodiment, the mobile communication device is a mobile phone 12 for use in carrying out mobile communications. Those having ordinary skill in the art will appreciate, however, that the present invention has utility with virtually any type of mobile communication device. Accordingly, the scope of the present invention in the broadest sense is not intended to be limited to a mobile phone.

The mobile phone 12 as shown in FIG. 2 has a “brick” or “block” design type housing. It will be appreciated, however, that other type housings such as clamshell or slide-type housings may be utilized without departing from the scope of the invention. The mobile phone 12 includes a conventional display 14 and keypad 16. The display 14 displays information to a user such as operating state, time, phone numbers, contact information, various navigational menus, etc., which enable the user to utilize the various features of the mobile phone 10. Similarly, the keypad 16 may be conventional in that it provides for a variety of user input operations. For example, the keypad 16 typically includes alphanumeric keys for allowing entry of alphanumeric information such as telephone numbers, phone lists, contact information, notes, etc. In addition, the keypad 16 typically includes special function keys such as a “call send” key for initiating or answering a call, and a “call end” key for ending, or “hanging up” a call. Special function keys may also include menu navigation keys, for example, for navigating through a menu displayed on the display 14 to select different phone functions, profiles, settings, etc., as is conventional. Other keys included in the keypad 16 may include a volume key, on/off power key, as well as various other keys such as a web browser launch key, camera key, etc. One key may be a key dedicated to allowing the user to select PTT proximity-based configuration in accordance with the invention described herein.

In the particular embodiment of FIG. 2, the mobile phone 12 includes the display 14 and separate keypad 16. In an alternative embodiment, the display 14 may comprise a touchscreen which itself includes one or more keys. In yet another embodiment, the display 14 may comprise a touchscreen that includes all or substantially all of the keys used to operate the phone 10 so as to include a very limited keypad 16 or no keypad 16 at all. As will be appreciated, the particular form and function of the keys included in the keypad 16 or touchscreen/display 14 are not germane to the invention in its broadest sense.

The mobile phone 12 further includes a PTT button 18 for carrying out PTT communication in walkie-talkie style. The PTT button 18 enables a user to “key” a communication to the recipients when wishing to transmit a communication thereto. The user releases the PTT button 18 in order to listen to return communications from those receiving the communication. Although the mobile phone 12 as shown has a dedicated PTT button 18, it will be appreciated that the PTT button need not be dedicated and may instead provide other functions without departing from the scope of the invention.

FIGS. 3A-3E illustrate different manners in which the initiating mobile phone 12 may present members in a given group or list of individuals with priority in accordance with the present invention. FIG. 3A represents the group or buddy list presented on the display 14 under conventional conditions when PTT proximity-based configuration capabilities are not implemented. As is shown, all group members of “Workgroup3” are shown without particular priority. Rather, the group members are presented simply in alphabetical order. FIG. 3B illustrates an embodiment in which the initiating mobile phone 12 may prioritize the group members in order of closest to furthest from a waypoint based on the requested location information. In the example of FIG. 1, Buddy C is presented at the top of the list as Buddy C is closest to the waypoint representing the Supplier. Buddies D, B and A follow in order from closest to furthest.

FIG. 3C illustrates an embodiment in which the initiating mobile phone 12 presents on the display 14 only the group members within a predetermined radius from the waypoint. Thus, in the example of FIG. 1, the initiating mobile phone 12 presents only Buddies C and D to the user. In the embodiment of FIG. 3D, the initiating mobile phone 12 presents only the closest group member to the waypoint. In the example of FIG. 1, this would be Buddy C. FIG. 3E illustrates another embodiment in which all of the group members are displayed in their original order, for example. The members are prioritized via highlighting (e.g., shading, cursor, etc.) rather than a change in order or the like.

In each of the above-discussed embodiments, the user of the initiating phone 12 can then select desired recipient(s) from the location prioritized group in order to send a PTT communication without necessarily including everyone ordinarily within the group. Other display mechanisms can be utilized without departing from the scope of the invention as will be appreciated.

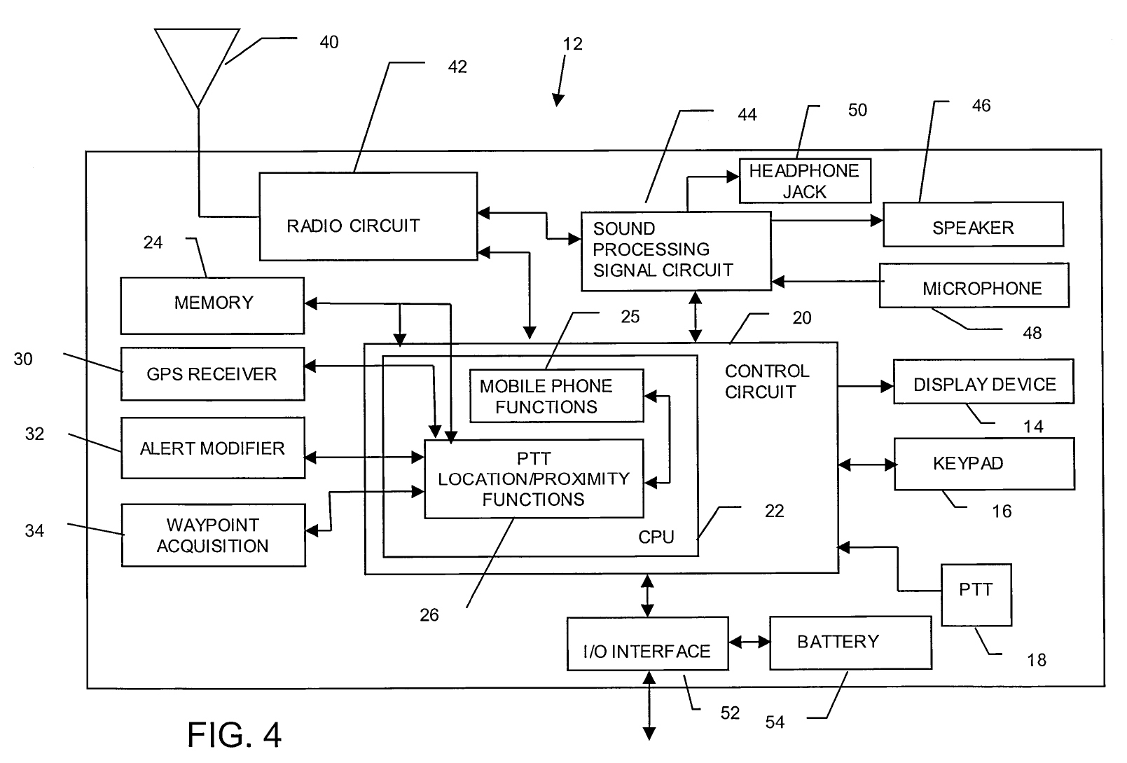

FIG. 4 represents a functional block diagram of an initiating or recipient mobile phone 12 in accordance with the present invention. It will be appreciated that not all features are necessary in all initiating or recipient mobile phones. Some phones 12 may have more limited capability than other phones without departing from the scope of the invention. For example, the initiating phone need not include a GPS receiver or the like to ascertain position if the waypoint information is other than that of the initiating mobile phone itself.

The construction of the mobile phone 12 is generally conventional with the exception of the PTT proximity-based configuration capabilities described herein. Preferably, the PTT proximity-based configuration capabilities are implemented primarily via application software within the mobile phones 12. However, it will be apparent to those having ordinary skill in the art that such operation can be carried out via primarily software, hardware, firmware, or combinations thereof, without departing from the scope of the invention.

The mobile phones 12 includes a primary control circuit 20 that is configured to carry out overall control of the functions and operations of the mobile phone 10. The control circuit 20 may include a CPU, microcontroller, or microprocessor, etc., collectively referred to herein simply as a CPU 22. The CPU 22 executes code stored in memory (not shown) within the control circuit 20, and/or in a separate memory 24 in order to carry out conventional operation of the mobile phone functions 25 within the mobile phone 10. In addition, however, the CPU 22 executes code stored in the memory 24 in accordance with the present invention in order to perform a PTT proximity-based configuration functions 26 as will be explained more fully below.

As illustrated in FIG. 4, the mobile phone 12 includes a GPS receiver 30 or other means for obtaining location information of the mobile phone 12 itself. GPS receivers 30 within mobile phones are very common nowadays. Thus, additional details are omitted for sake of brevity. The mobile 12 also may include an alert modifier function 32. As will be discussed in more detail below, an initiating mobile phone 12, upon receiving location information on which priority may be based, can transmit an alert notifier to the recipient mobile phones 12 indicating the particular recipient mobile phone 12 is considered higher priority. The recipient mobile phone 12 is designed to modify its alert signal (e.g., the particular ring tone or the like) based on the receipt of the alert notifier. This way, the user of a recipient mobile phone 12 will be alerted that he or she is a prioritized member of the incoming PTT communication.

The mobile phone 12 also preferably includes a waypoint acquisition function 34. As mentioned above, the waypoint acquisition 34 may be carried out via an input from the keypad 16, by downloading the waypoint from a website, by optically scanning in a waypoint, etc. Preferably the waypoint information is in the form of GPS coordinates or some other form compatible with the location information that is received/provided from the other mobile phones 12.

Continuing to refer to FIG. 4, the mobile phone 12 includes an antenna 40 coupled to a radio circuit 42. The radio circuit 42 includes a radio frequency transmitter and receiver for transmitting and receiving signals via the antenna 40 as is conventional. The mobile phone 12 further includes a sound processing circuit 44 for processing the audio signal transmitted by/received from the radio circuit 42. In addition, the sound processing circuit 44 serves to process the audio signal provided by the control circuit 20 during playback of media objects. Coupled to the sound processing circuit 44 are a speaker 46, and a microphone 48 which enable a user to listen and speak via the mobile phone 10 as is conventional. In addition, a headphone jack 50 coupled to the sound processing circuit 44 is optionally provided. This allows a headset (not shown) to be connected to the mobile phone 12. The radio circuit 42 and sound processing circuit 44 are each coupled to the control circuit 40 so as to carry out overall operation.

The mobile phone 12 also includes the aforementioned display 14, keypad 16 and PTT key 18 coupled to the control circuit 20. The mobile phone 12 further includes an I/O interface 52. The I/O interface 52 may be in the form of any one of many typical mobile phone I/O interfaces, such as a multi-element connector at the base of the mobile phone 12. As is typical, the I/O interface 52 may be used to couple the mobile phone 12 to a battery charger to charge a power supply unit (e.g., battery) 54 within the mobile phone 12. In addition, or in the alternative, the I/O interface 52 may serve to connect the mobile phone 10 to a wired personal hands-free adaptor (not shown). Further, the I/O interface 52 may serve to connect the mobile phone 12 to a personal computer or other device via a data cable, etc. As another alternative, the I/O interface 52 may serve to connect the mobile phone 12 to a docking station including an audio amplifier, speakers and/or video display to allow for enhanced viewing/listening of the media objects as part of the media player function.

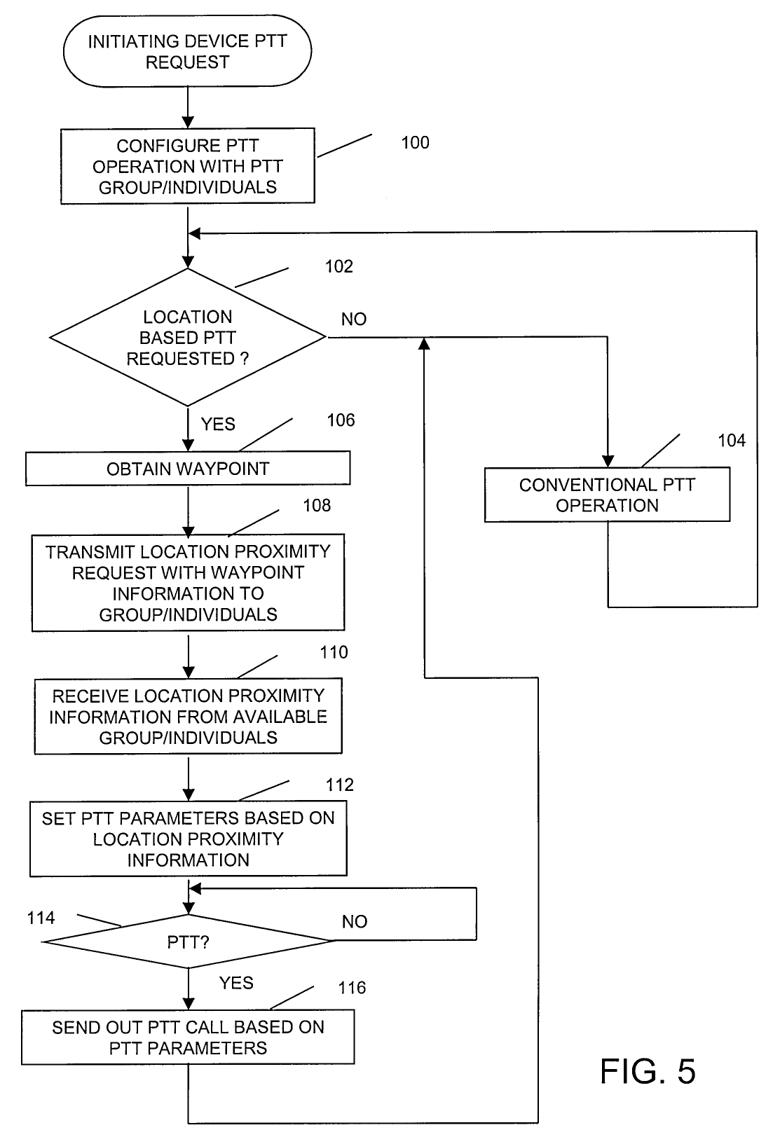

FIG. 5 is a flowchart representing the operation of a mobile phone 12 serving as an initiating mobile phone 12 in accordance with the principals of the present invention. Beginning in step 100, the initiating mobile phone configures itself to operate in conventional PTT mode with the recipient mobile phones 12 of individuals and/or groups of individuals included in the contacts list of the mobile phone. Such contacts list typically will be stored in memory 24 of the mobile phone 12 as will be appreciated.

Next, in step 102 the initiating mobile phone determines if the user has requested PTT proximity-based configuration operation in accordance with the invention. As mentioned above, the user may select such operation by pressing a button or key, navigating thru a menu, etc. If the user does not select PTT proximity-based configuration operation in step 102, the initiating mobile phone simply proceeds to step 104 and carries out conventional PTT operation.

In the event the user does select PTT proximity based configuration operation as determined in step 102, operation proceeds to step 106 in which the initiating mobile phone obtains waypoint information. The mobile phone may prompt the user to enter such information via the display 14. Alternatively, the mobile phone may be configured to default to the location of the initiating mobile phone itself and enter the GPS coordinates of the initiating mobile phone as the waypoint information in step 106. The user may then be prompted to confirm the waypoint information and/or to enter new waypoint information. As yet another alternative, the initiating mobile phone may be configured to access automatically a web site that enables the user to enter an address or other known location. The web site in turn provides to the initiating mobile phone the GPS coordinates of the address or other known location as the waypoint information. Alternatively, the initiating mobile phone may be configured to access waypoint information via a shared database as discussed above.

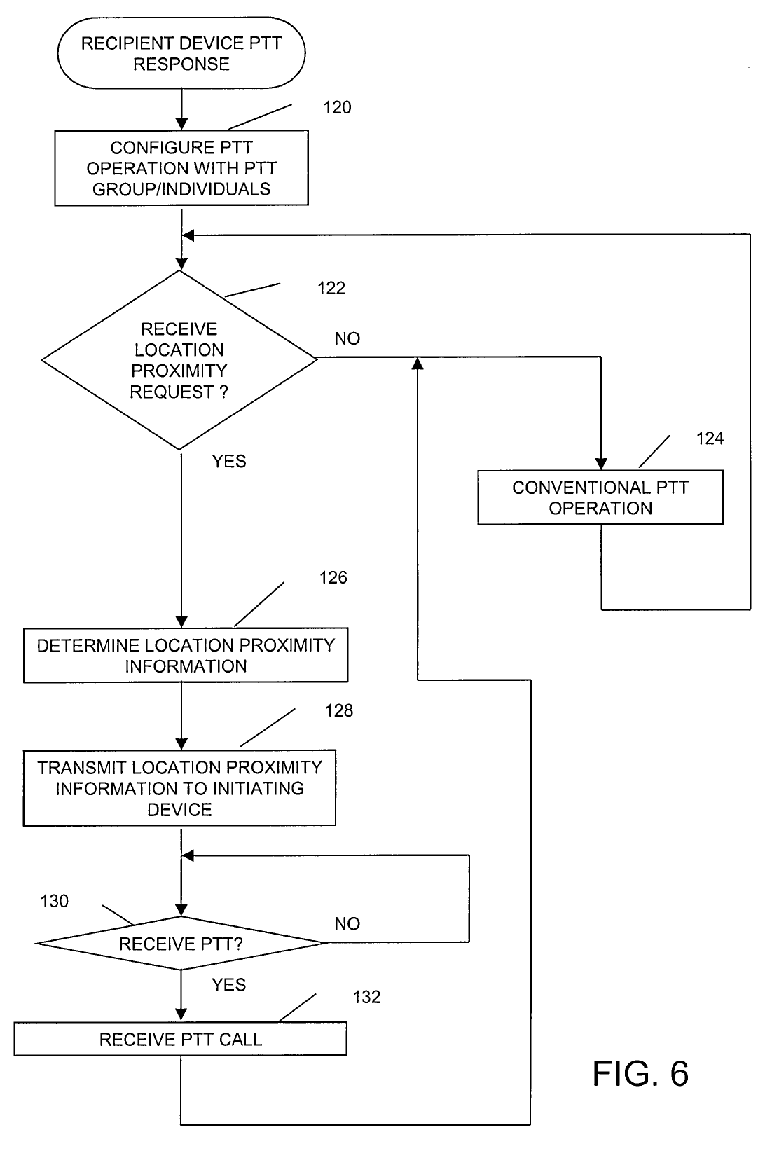

Following step 106, the initiating mobile phone in step 108 is configured to automatically transmit location proximity requests with the waypoint information to all of the individuals or group members selected by the user for PTT communication. The location proximity requests preferably are information packets transmitted between the mobile phones via their respective wireless transceivers over the system network 10. The mobile phones are configured to communicate via the information packets in the background so as not to disrupt the user. As is explained below with respect to FIG. 6, the available mobile phones receiving the location requests from the initiating mobile phone as sent in step 108, are configured to respond to the initiating mobile phone with location proximity information as represented in step 110.

Based on the location proximity information returned to the initiating mobile phone in step 110, the initiating mobile phone in step 112 compares the information to determine which particular individuals and/or group members in the PTT list are closest to the waypoint. By applying any one of the criteria exemplified above in FIGS. 3B-3E, or any other criteria, the initiating mobile phone can determine which recipient mobile phones have priority over the others. The initiating mobile phone in step 112 may then set or configure the PTT parameters based on the location proximity information as represented in step 112. Such configuration may be the manner in which the individuals and/or group members are displayed on the display 14 as represented in FIGS. 3B-3E, for example, although it will be appreciated that other means for prioritizing the individuals and/or group members based on the location information is considered well within the scope of the present invention.

Following step 112, the initiating mobile phone proceeds to step 114 where it determines if the user has in turn initiated a PTT communication. For example, the initiating mobile phone determines whether the user has selected one or more of the prioritized individuals and/or group members and engaged the PTT button 18. If yes, the initiating mobile phone proceeds to step 116 in which the PTT communication is sent out to the priority based recipient mobile phones. PTT communications then continue between the participating mobile phones in conventional manner as represented in step 104. If the PTT communication is not yet initiated as determined in step 114, the mobile phone loops around step 114 until the user carries out the initiation.

FIG. 6 is a flowchart illustrating the operation of the recipient mobile phones in accordance with the present invention. Beginning in step 120, the recipient mobile phones configure themselves for conventional PTT operation analogous to step 110 in the initiating device as discussed above with respect to FIG. 5. Next, in step 122 the recipient mobile phone determines if it has received a location proximity request from an initiating device (step 108 in FIG. 5). If not, the recipient mobile phone continues in conventional PTT operation as represented by step 124 in FIG. 6.

If the recipient mobile phone does receive a location proximity request as determined in step 122, the recipient mobile phone proceeds to step 126 in which it determines its location proximity information. For example, the recipient mobile phone determines its location based on the output of its GPS receiver 30 (FIG. 4). The recipient mobile phone may calculate its proximity to the waypoint based on a comparison of the waypoint location information and the location of the mobile phone itself. The recipient mobile phone in step 128 proceeds to respond to the location request by transmitting its location proximity information to the initiating mobile phone (received in step 110 as represented in FIG. 5).

Next, in step 130 the recipient mobile phone determines if it has received a PTT communication as a result of step 116 of the initiating mobile phone as represented in FIG. 5. If yes, the recipient mobile phone 130 receives the PTT communication as represented in step 132. The recipient mobile phone then proceeds to communicate in a conventional manner as represented in step 124.

Although not shown in FIGS. 5 and 6, in one embodiment if the initiating mobile phone determines a recipient mobile phone(s) is prioritized based on the location information, the initiating mobile phone in step 112 sends an alert notification to the recipient mobile phone(s) meeting the prioritization criteria. Recipient mobile phones having an alert modifier function 32 (FIG. 4) can modify their alert signals (e.g., ring tones) based on the receipt of such alert modifier in between steps 128 and 130 in FIG. 6. Thus, a user of a recipient mobile phone will be alerted to his or her priority status by a characteristic alert.

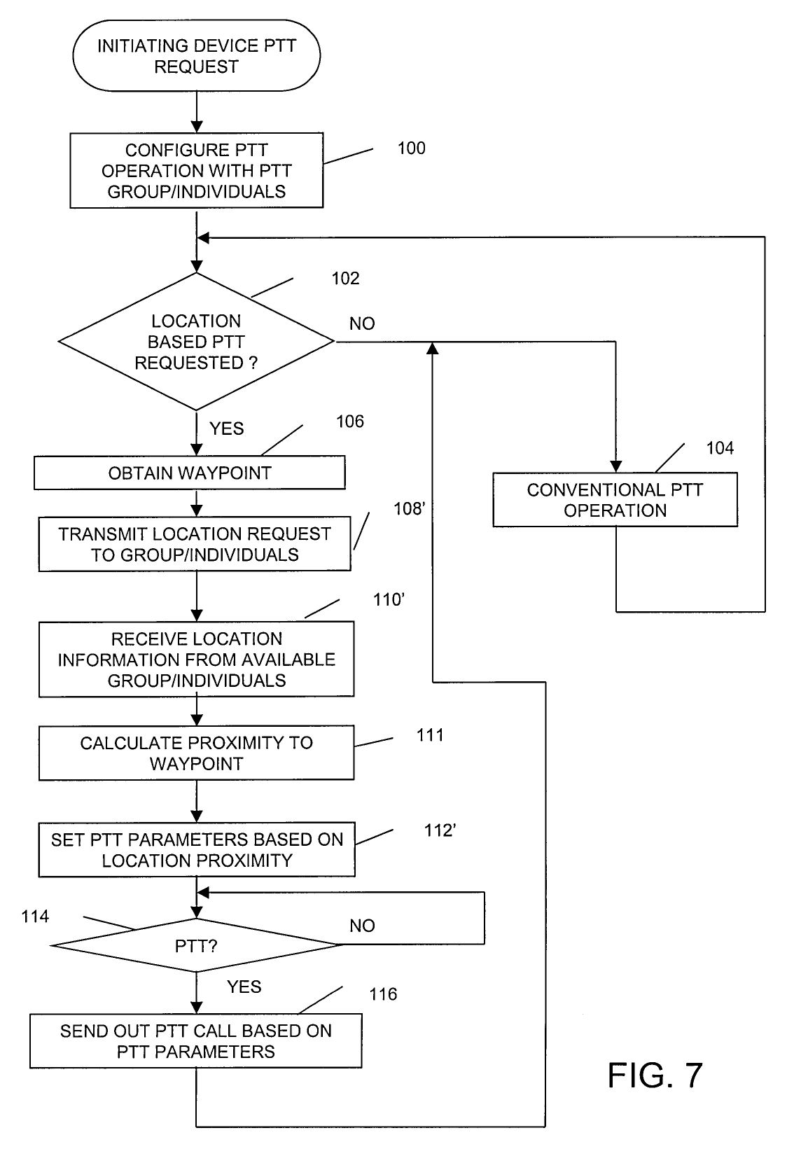

FIG. 7 is a flowchart representing an alternative embodiment of the present invention with respect to the initiating mobile phone. Operation is essentially identical to that described above with respect to the embodiment of FIG. 5, with the following exception. Rather than the initiating mobile phone providing the waypoint information to the recipient mobile phones as in step 108 in FIG. 5, the initiating mobile phone simply retains the waypoint information. Thus, in step 108′ the initiating mobile phone transmits location proximity requests to the recipient mobile phones simply requesting their respective locations (i.e., their respective absolute location). In step 110′, the initiating mobile phone receives the location information of the recipient mobile phones. In step 111, the initiating mobile phone calculates the proximity of the respective recipient mobile phones relative to the waypoint. Next, in step 112′ the initiating mobile phone itself determines which recipient mobile phones are closest/further from the waypoint based on the initiating mobile phone's comparison of the respective locations and the waypoint. Operation then proceeds as described above. In other words, the embodiment of FIG. 7 calls upon the initiating mobile phone to perform the actual comparison between the locations of the recipient mobile phones relative to the waypoint.

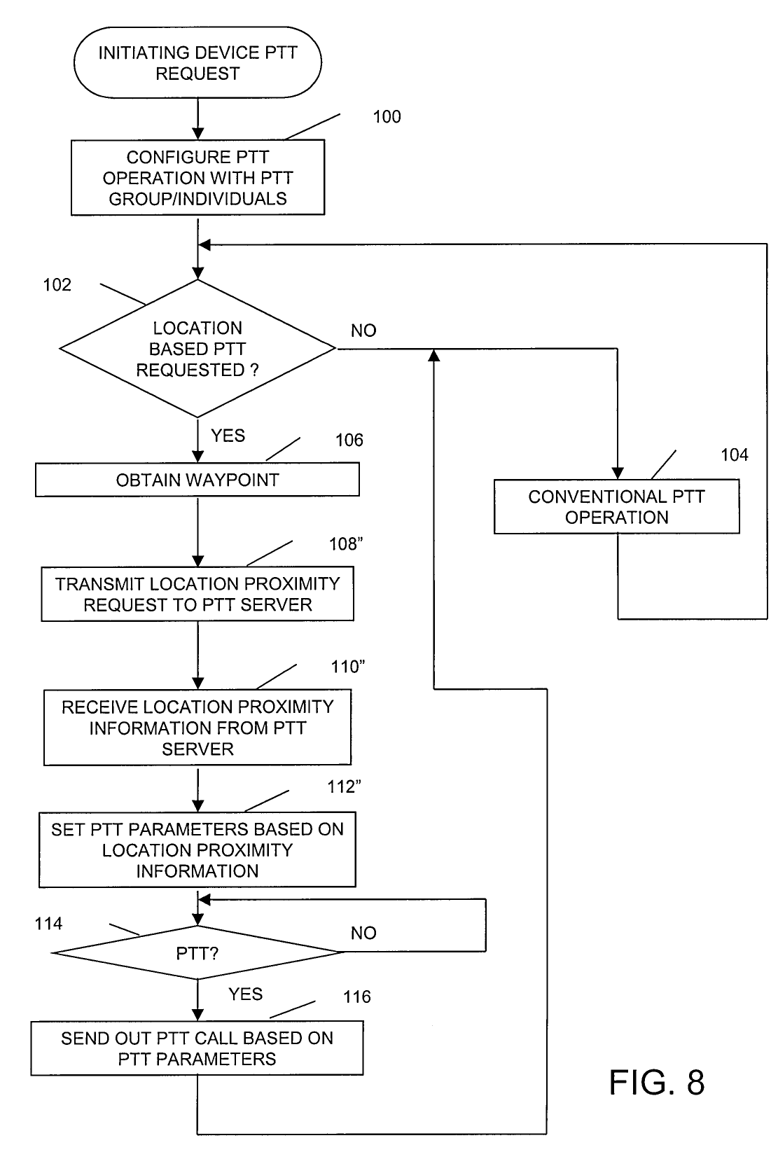

FIG. 8 illustrates yet another alternative. In this particular embodiment, the initiating mobile phone in step 108″ transmits the location proximity request to the PTT system server 14 (FIG. 1) rather than directly to the recipient mobile phones. The system server 14 may be tasked with obtaining the location information from the recipient mobile phones. The location information may be relative to a waypoint provided by the initiating mobile phone, actual location, etc. Moreover, the system server 14 may be tasked with simply providing the location information to the initiating mobile phone in step 110″. Alternatively, the system server 14 may be tasked with applying predefined criteria to the location information so as to determine itself any particular priority among the recipient mobile phones based on the location information. In this manner, the system server 14 can provide location proximity information to the initiating mobile phone in step 110″ with the relevant priority already determined. Thus, in step 112″ the initiating mobile phone may prioritize the recipient mobile phones based on the priority information provided by the system server 14. In other words, the initiating mobile phone may push off some and/or all of its functions to a system server 14 without departing from the scope of the invention.

The terms “mobile communication device” and “electronic equipment” as referred to herein include portable radio communication equipment. The term “portable radio communication equipment”, also referred to herein as a “mobile radio terminal”, includes all equipment such as mobile phones, pagers, communicators, e.g., electronic organizers, personal digital assistants (PDAs), smartphones or the like.

Although the invention has been shown and described with respect to certain preferred embodiments, it is obvious that equivalents and modifications will occur to others skilled in the art upon the reading and understanding of the specification. For example, while the invention has been described primarily in the context of mobile phones, the invention is equally applicable to other types of mobile communication devices. Furthermore, although the invention has been described primarily in the context of PTT communications, the location-based configuration can be applied to other forms of communication without departing from the broad scope of the present invention.

The present invention includes all such equivalents and modifications, and is limited only by the scope of the following claims.

1. A mobile communication device, comprising:
a wireless transceiver;
a memory for storing contact information relating to other mobile communication devices of individuals and/or groups of individuals with whom the mobile communication device may communicate via the wireless transceiver; and
a proximity-based configuration processor that receives location information relating to locations of the other mobile communication devices, and configures the mobile communication device to communicate with the other mobile communication devices of the individuals and/or groups of individuals with a priority based on the location information.

2. The mobile communication device of claim 1, wherein the proximity-based configuration processor is configured to receive the location information from the other mobile communication devices themselves.

3. The mobile communication device of claim 1, wherein the proximity-based configuration processor is configured to receive the location information from a system server responsible for providing such information.

4. The mobile communication device of claim 2, wherein the proximity-based configuration processor is configured to transmit location information requests to the other mobile communication devices to initiate receipt of the location information.

5. The mobile communication device of claim 4, wherein the location information requests include at least one waypoint with respect to which the location of the other mobile communications devices is requested.

6. The mobile communication device of claim 4, wherein the proximity-based configuration processor determines the location of the other mobile communication devices relative to a waypoint based on the received location information.

7. The mobile communication device of claim 3, wherein the proximity-based configuration processor is configured to transmit a request for the location information to the system server.

8. The mobile communication device of claim 7, wherein the location information requests include at least one waypoint with respect to which the location of the other mobile communications devices is requested.

9. The mobile communication device of claim 1, wherein the memory includes a group of individuals, and the proximity-based configuration processor effectuates the priority in a manner in which the group of individuals is displayed to a user in preparation for initiating a push-to-talk (PTT) communication.

10. The mobile communication device of claim 9, wherein a display of the group of individuals is prioritized in that group members having a nearer location relative to a waypoint are identified with higher priority than group members having a further location.

11. The mobile communication device of claim 9, wherein a display of the group of individuals is prioritized in that group members beyond a predetermined distance of a waypoint are not displayed within the group.

12. The mobile communication device of claim 9, wherein a display of the group of individuals is prioritized in that only the group member closest to a waypoint is displayed within the group.

13. A system comprising the mobile communication device of claim 1, and further comprising the other mobile communication devices, wherein each of the other mobile communication devices includes:
location determination circuitry for determining a location of the other mobile communication device; and
a wireless transceiver for communicating location information based on the determined location.

14. The system of claim 13, wherein each of the other mobile communication devices is configured to receive location information requests from another mobile device, and to respond by communicating the location information based on the determined location to the mobile device issuing the location information request.

15. The system of claim 14, wherein the location information communicated by each of the other mobile communication devices comprises the absolute location of the mobile communication device.

16. The system of claim 14, wherein the location information communicated by each of the other mobile communication devices comprises the location of the mobile communication device relative to a waypoint provided in the information requests.

17. The system of claim 13, wherein each of the other mobile communication devices is configured to receive location information requests from a system server, and to respond by communicating the location information based on the determined location to the system server.

18. The system of claim 17, further comprising the system server.

19. A method of conducting PTT communications among mobile communication devices, comprising the steps of:
presenting a group of individuals with whom the mobile communication devices may communicate via a PTT communication; and
prioritizing the group of individuals for purposes of the PTT communication based on location information relating to the locations of the individuals.

20. The method of claim 19, wherein the location information relates to the locations of the individuals relative to a predefined waypoint.

21. The method of claim 20, wherein the group of individuals are prioritized by displaying the group members on a mobile communication device initiating the PTT communication in an order based on proximity to the waypoint.

22. The method of claim 20, wherein the group of individuals are prioritized by displaying a reduced number of group members based on their proximity to the waypoint.

23. The method of claim 20, wherein the predefined waypoint is acquired from a database shared among the group of individuals.
